(19) United States
(12) Patent Application Publication
(10) Pub. No.: US 2025/0066395 A1
(43) Pub. Date: Feb. 27, 2025

(54) Detecting and Separating Rare Earth Metal Mixtures

(71) Applicant: Board of Regents, The University of Texas System, Austin, TX (US)

(72) Inventors: Skye Fortier, El Paso, TX (US); Juan Ricardo Luna, El Paso, TX (US)

(21) Appl. No.: 18/804,637

(22) Filed: Aug. 14, 2024

Related U.S. Application Data
(60) Provisional application No. 63/578,871, filed on Aug. 25, 2023.

(51) Int. Cl. C07F 9/38; G01N 24/08

(52) U.S. Cl. CPC C07F 9/38; G01N 24/08

(57) ABSTRACT

Rare earth elements can be bonded as a set of metallophosphonic acid chelates to form a set of chelation complexes, followed by detecting at least one of the set of rare earth elements in the set of chelation complexes using nuclear magnetic resonance, followed by separating at least one of the set of rare earth elements in the set of chelation complexes using at least one solvent. The set of metallophosphonic acid chelates can include a set of Kläui ligands and detecting can include detecting specific individual elements from among the set of rare earth elements.

### CROSS-REFERENCE TO RELATED APPLICATION

Referring to the application data sheet filed herewith, this application claims a benefit of priority under 35 U.S.C. 119 (e) from co-pending provisional patent application U.S. Ser. No. 63/578,871, filed Aug. 25, 2023, the entire contents of which are hereby expressly incorporated herein by reference for all purposes.

### BACKGROUND

The rare earth elements (REEs) include the lanthanide elements plus scandium and yttrium, which have similar physical properties and are often found in the same ores and deposits. REEs include the light REEs such as lanthanum, cerium, praseodymium, neodymium, samarium, europium. REEs also include the heavy REEs (HREEs) gadolinium, terbium, dysprosium, holmium, erbium, thulium, ytterbium, lutetium, scandium and yttrium. While most of these elements are not actually rare in terms of the general amount of these elements in the earth's crust, they are rarely found in sufficient abundance in a single location for their mining to be economically viable. REEs have many important applications in modern technology for which there is no equal substitute, but an increasing demand for these elements is straining supply.

Another problem with this technology has been the rapid and quantitative detection of specific individual rare earth elements. Therefore, what is also required is a solution that enables detection of individual rare earth elements.

Another problem with this technology has been the separation of specific individual rare earth elements. Therefore, what is also required is a solution that enables efficient separation of individual rare earth elements.

Heretofore, the requirement(s) of detection and separation referred to above have not been fully met. In view of the foregoing, there is a need in the art for a solution that simultaneously solves both of these problems.

### SUMMARY

There is a need for the following embodiments of the present disclosure. Of course, the present disclosure is not limited to these embodiments.

Embodiments of this disclosure can include a metallophosphonic acid chelate for the spectroscopic detection and separation of rare earth element mixtures. The metallophosphonic acid chelate can include Kläui ligand, which generally describes a chelator including a metallocene fragment supported by phosphonic acids. The spectroscopic detection can include nuclear magnetic resonance. The separation can include use of solvents such as water and/or ethyl acetate.

According to an embodiment of the present disclosure, a process comprises: bonding chemically a set of rare earth elements to a set of metallophosphonic acid chelates to form a set of chelation complexes; detecting at least one of the set of rare earth elements in the set of chelation complexes using nuclear magnetic resonance spectroscopy; and separating at least one of the set of rare earth elements in the set of chelation complexes using at least one solvent. The set of metallophosphonic acid chelates can include a set of Kläui ligands. Detecting can include detecting specific individual elements from among the set of rare earth elements.

These and other embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings.

The described embodiments may be better understood by reference to one or more of these drawings in combination with the following description presented herein. It should be noted that the features illustrated in the drawings are not necessarily drawn to scale.

FIG. 1 illustrates phosphorous-31 nuclear magnetic resonance spectra of rare earth element Kläui chelates, showing each chelation complex to possess a distinctive value.

FIG. 2 illustrates phosphorous-31 nuclear magnetic resonance spectra of more rare earth element Kläui chelate complexes.

FIG. 3 illustrates extraction (separation) of rare earth elements using phase separation methods.

FIG. 4 illustrates phosphorous-31 nuclear magnetic resonance spectra of more Kläui-REE chelate complexes.

FIG. 5 illustrates phosphorous-31 nuclear magnetic resonance spectra showing identification of individual REEs in a mixture of REE Kläui chelate.

FIG. 6 illustrates phosphorous-31 nuclear magnetic resonance spectra showing the regeneration of REE-free Kläui chelate upon progressive treatment of an aqueous solution of Kläui-rare earth chelates with aqueous sodium hydroxide (bottom to top progression).

FIG. 7 illustrates simulated data demonstrating the selective separation of rare earth elements (Sm, Lu, Y, La) via incremental addition of sodium hydroxide, highlighting the sequential removal of Lu, Y, Sm, leaving La.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well-known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

In general, the context of an embodiment of the present disclosure can include processing rare earth minerals. The context of an embodiment of the present disclosure can include detecting individual rare earth elements. The context of an embodiment of the present disclosure can also include separating individual rare earth elements.

This disclosure highlights a simplified method in detecting specific chelated rare earth metals (REEs) using nuclear magnetic resonance (NMR) instrumentation once bonded to the Kläui chelate due to their unique phosphorus-31 NMR (³¹P NMR) signature.

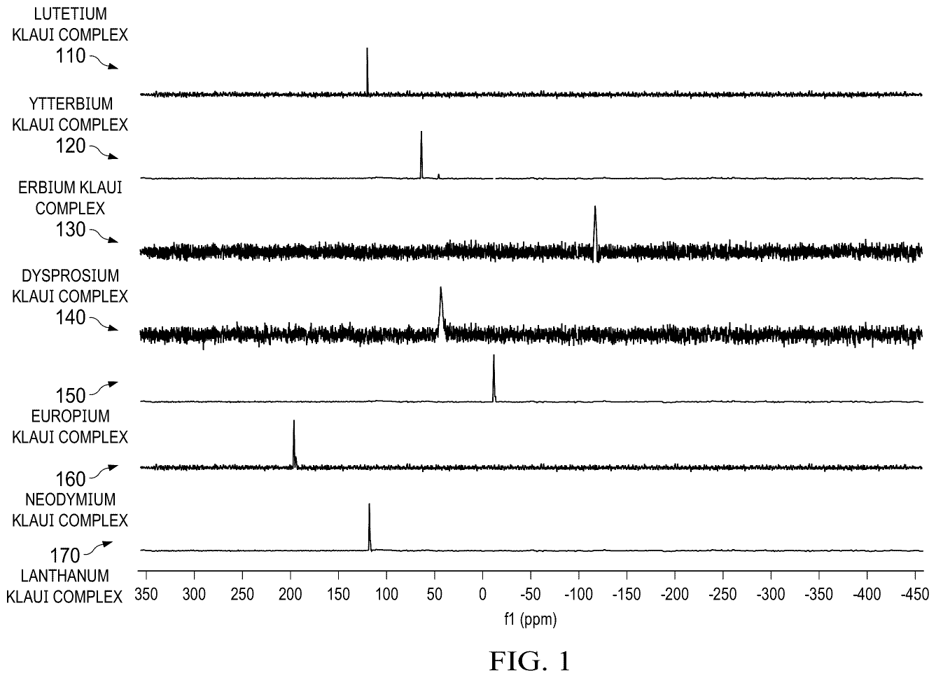

FIG. 1 shows the unique phosphorus-31 NMR (³¹P NMR) signatures for specific individual REE chelation complexes. Lutetium Kläui complex trace 110 has a single signature peak. Ytterbium Kläui complex trace 120 has a specific singular peak. Erbium Kläui complex trace 130 has a single signature peak. Dysprosium Kläui complex trace 140 has a specific signature peak. Europium Kläui complex trace 150 has a specific signature peak. Neodymium Kläui complex trace 160 has a singular signature peak period. Lanthanum Kläui complex trace 170 has a single signature peak. Each of these signature peaks is significantly different from the others enabling detecting specific individual elements from among the set of rare earth elements.

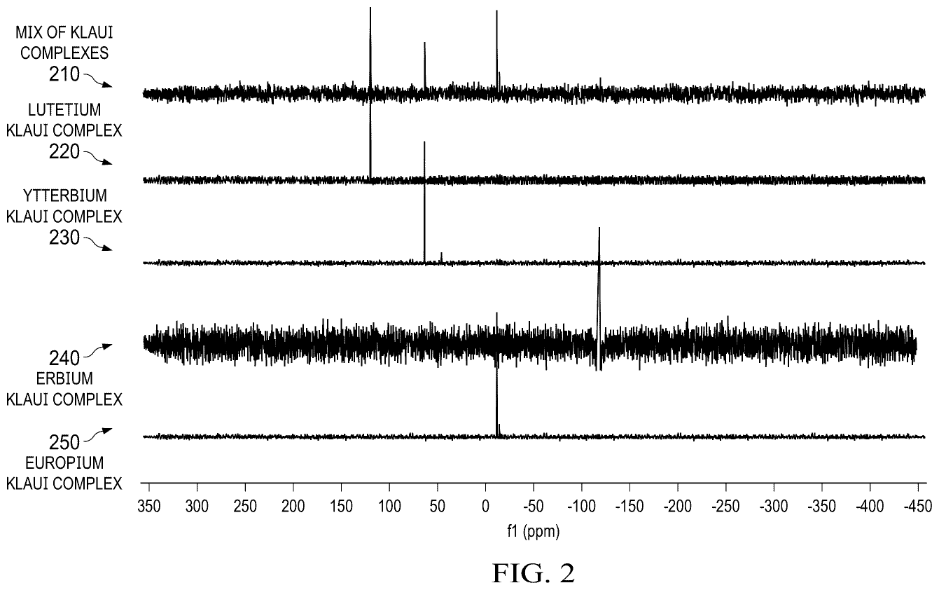

FIG. 2 is a continuation of FIG. 1 and shows phosphorous-31 nuclear magnetic resonance spectra of more rare earth element Kläui chelate complexes. In FIG. 2, mix of Kläui complexes trace 210 shows a plurality of signature peaks where each of these signature peaks corresponds to a separate rare earth element. Lutetium Kläui complex trace 220 has a single signature peak that aligns with the corresponding lutetium peak in the mix of Kläui complexes trace. Ytterbium Kläui complex trace 230 exhibits a single signature peak that aligns with the corresponding ytterbium peak in the mix of Kläui complexes trace. Erbium Kläui complex trace 240 has a single signature peak that aligns with the corresponding erbium peak in the mix of Kläui complexes trace. Europium Kläui complex trace 250 exhibits a singular signature peak little aligns with the corresponding europium peak in the mix of Kläui complexes trace.

Embodiments of this disclosure can include rare earth metal detection on-site (e.g., at a mine). Further, embodiments of this disclosure can include rare earth metal separation on-site (e.g., near a mine).

Once the REE is bonded to the Kläui ligand, solubility properties change across the series of elements. Table 1 shows the trend we have seen in the REE series for our investigation. We have selected water and ethyl acetate (EtOAc) for their “green solvent” properties of being safe to handle, eco-friendly, little to no hazardous waste, etc.

As illustrated in Table I (set forth below), light REE Kläui complexes lanthanum, cerium, praseodymium, neodymium, samarium, and europium are soluble in EtOAc (ethyl acetate). Heavy REE Kläui complexes gadolinium, terbium, dysprosium, holmium, erbium, thulium, ytterbium, lutetium, scandium and yttrium are soluble in water. Of note, Kläui complex europium is also soluble in water.

TABLE I

| RRE Kläui | Soluble in | Soluble in |
|---|---|---|
| complex | EtOAc | water |
| Lanthanum | ✓ | |
| Cerium | ✓ | |
| Praseodymium | ✓ | |
| Neodymium | ✓ | |
| Samarium | ✓ | |
| Europium | ✓ | ✓ |
| Gadolinium | | ✓ |
| Terbium | | ✓ |
| Dysprosium | | ✓ |
| Holmium | | ✓ |
| Erbium | | ✓ |
| Ytterbium | | ✓ |
| Lutetium | | ✓ |

Utilization of “green” solvents for REE separations

Embodiments of this disclosure include a simplified, eco-friendly approach to separate REE salts using solvent layered separation that has the potential for application of REE extraction from ore samples. This solvent layered separation can be followed, optionally with detection as described above.

In addition to utilizing metallophosphonic acids (viz, Kläui chelate) for the detection and separation of rare earth elements, the Kläui chelate is acid compatible. This characteristic extends its applicability to metal extraction from acidic media, like nitric acid. This process involves the transfer of metals from the acidic solution to an organic medium utilizing phase separation techniques. An example of a practical utility of this separation would be the digestion of metal ores into acid media and subsequent extraction of the metal ions.

Digestion of rare earth metal oxides in nitric acid (or other aqueous acidic media including but not limited to hydrochloric acid, phosphoric acid, sulfuric acid, citric acid) to generate soluble metal ions that can subsequently undergo complexation with the Kläui chelate. Extraction of the Kläui-rare earth chelate is then accomplished by addition of an immiscible and acid compatible organic solvent, such as saturated hydrocarbons (e.g., kerosene) or petroleum oils, using phase-separation methods where the Kläui chelate metal complex will pass to the organic layer. Removal of the organic layer will produce the Kläui chelate metal complex as a solid that can subsequently be treated with water or other organic solvents, such as ethyl acetate (green solvent), for the selective separation of the metals as described in Table 2.

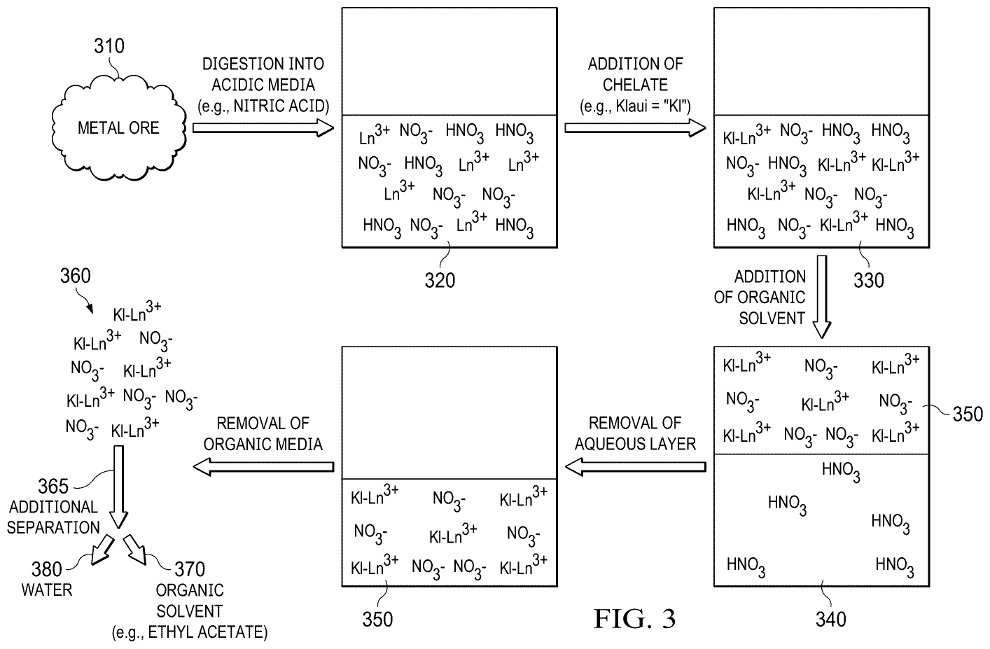

In FIG. 3, a metal ore 310 is provided. The metal ore can be provided from a mine, tailings pile or other suitable ore source. The ore is digested into an acidic media (e.g., nitric acid) forming a slurry 320. The addition of a chelate (e.g., Kläui) produces an aqueous mix of complexes 330. Addition of an organic solvent causes aqueous layer 340 to segregate when those complexes which are soluble in the organic solvent go into solution 350. Then, removal of the aqueous layer leaves solution 350. Removal of the organic media leaves solid 360. Additional separation 365 can be performed with an organic solvent 370 (e.g., ethyl acetate) and water 380.

### Examples

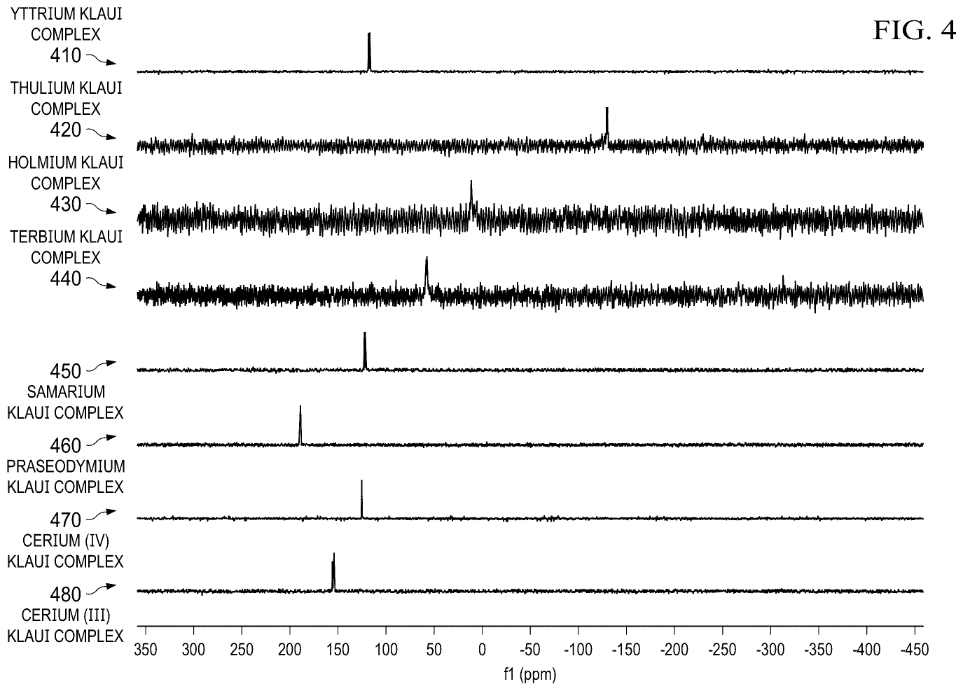

FIG. 4 shows the unique phosphorus-31 NMR (³¹P NMR) signatures for specific individual REE chelation complexes. Yttrium Kläui complex trace 410 has a single signature peak. Thulium Kläui complex trace 420 has a specific singular peak. Holmium Kläui complex trace 430 has a single signature peak. Terbium Kläui complex trace 440 has a specific signature peak. Samarium Kläui complex trace 450 has a specific signature peak. Prascodymium Kläui complex trace 460 has a singular signature peak period. Cerium (IV) Kläui complex trace 470 has a single signature peak. Cerium (III) Kläui complex trace 480 has a single signature peak. Each of the signature peaks in FIG. 4 is significantly different from the others enabling detecting specific individual elements from among the set of rare earth elements. FIG. 4 provides further evidence that the Kläui chelate can effectively bind a wide range of Rare Earth Elements (REEs), with each chelation complex possessing a distinctive value. This reinforces the versatility and applicability of embodiments of this disclosure.

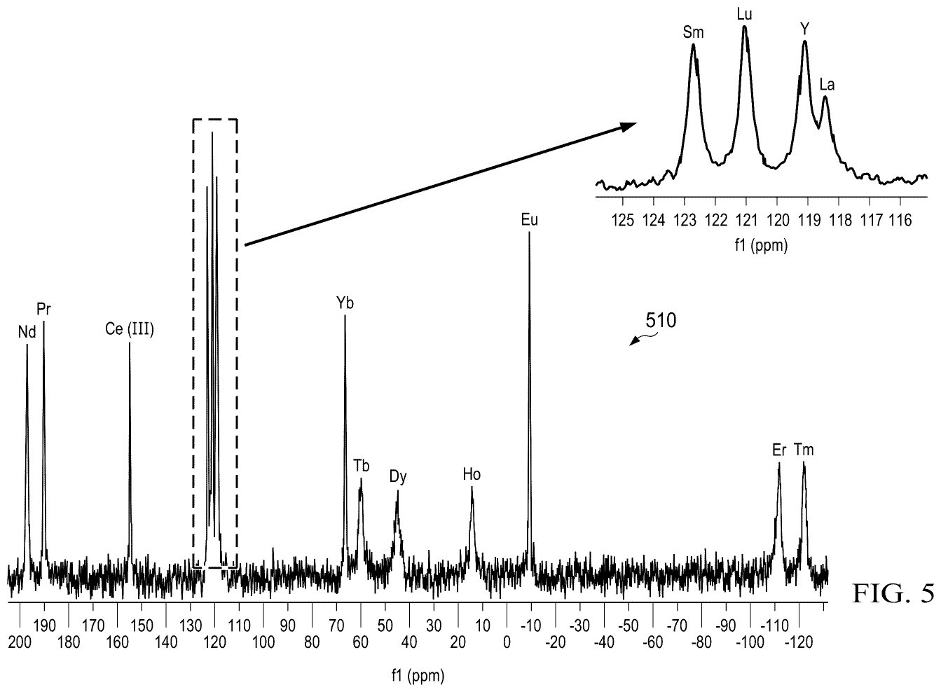

FIG. 5 shows phosphorus-31 NMR (³¹P NMR) data from a mix of Kläui complexes that includes a nearly complete series of Rare Earth Elements (REEs), compared to the handful of elements originally presented in trace 210 of FIG. 2. FIG. 5 shows that chelation is not affected when mixing solutions of rare earth element Kläui chelates. FIG. 5 offers a more comprehensive view, demonstrating that the Kläui chelate can effectively bind and identify REEs within a broader mixture. FIG. 5 is showcasing the versatility and reliability of our method across a wider range of REEs.

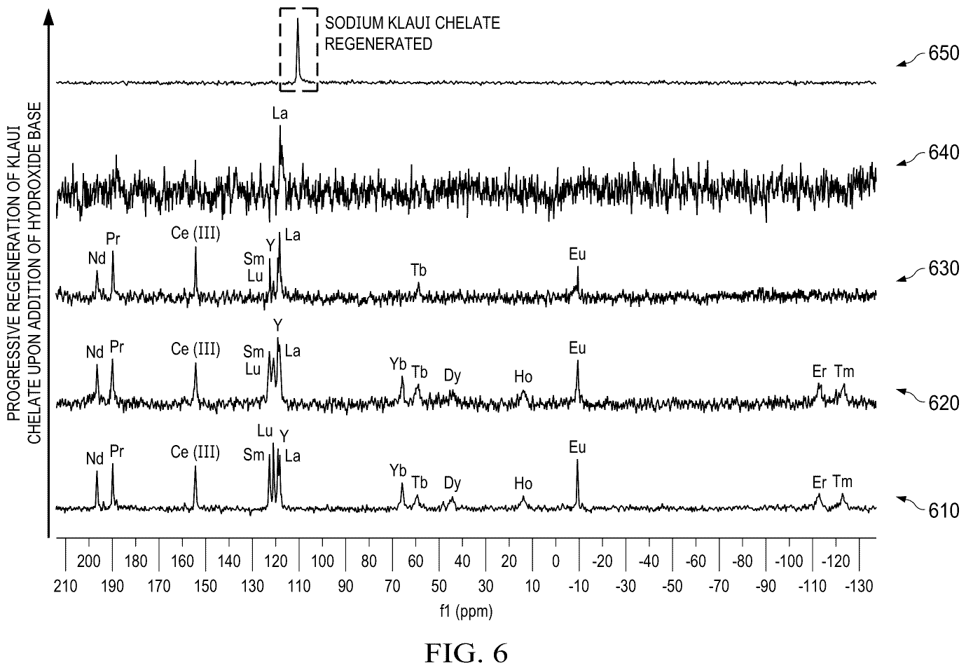

FIG. 6 illustrates empirical data demonstrating the method for the separation of rare earth elements from an aqueous mixture of Kläui-rare earth chelates through the incremental addition of sodium hydroxide. This method facilitates the regeneration of the free Kläui chelate as a sodium salt, as depicted in the progression of traces from bottom to top.

The bottom trace 610 delineates the initial aqueous mixture of Kläui-rare earth chelates prior to the introduction of sodium hydroxide. As sodium hydroxide is incrementally added, the second and third traces from the bottom 620, 630 exhibit a reduction in the concentration of metals within the solution. The top trace 650 demonstrates the complete removal of metals from the solution, thereby leaving only the regenerated Kläui chelate. Notably, the regenerated sodium Kläui chelate is recyclable and can be reintroduced into new mixtures of rare earth elements, thereby underscoring the method's efficiency and reusability. While this method utilizes sodium hydroxide, it is anticipated that the process is equally applicable with other hydroxide bases, such as potassium hydroxide, lithium hydroxide, or ammonium hydroxidc.

Importantly, the second trace from the top 640 highlights that lanthanum is the slowest element to be removed from the solution. This observation is critical as it demonstrates that the method can be employed to selectively remove rare earth elements from lanthanum, thus facilitating the selective extraction of lanthanum from rare earth mixtures.

Still referring to FIG. 6, treatment of Kläui-rare earth chelate solutions with hydroxide base liberates the Kläui with concomitant deposition of an insoluble mixture of rare earth element (e.g. lanthanum) oxides and hydroxides. This creates recoverability and recyclability of the Kläui chelate. In particular, titration of an aqueous solution of sodium hydroxide (NaOH) into an aqueous solution of the lanthanum Kläui complex, releases the Kläui to form a regenerated sodium Kläui chelate ligand while depositing an insoluble mixture of rare earth element (lanthanum) oxide and hydroxides. This sodium Kläui chelate ligand can then be reused to chelate another, potentially different, set of rare earth metals.

FIG. 6 shows that with a mix of Kläui-REE complexes, progressive addition of sodium hydroxide leads to the regeneration of the Kläui-chelate. As for other bases, any soluble hydroxide would work (lithium/sodium/potassium/rubidium/cesium hydroxide) and potentially ammonium hydroxide.

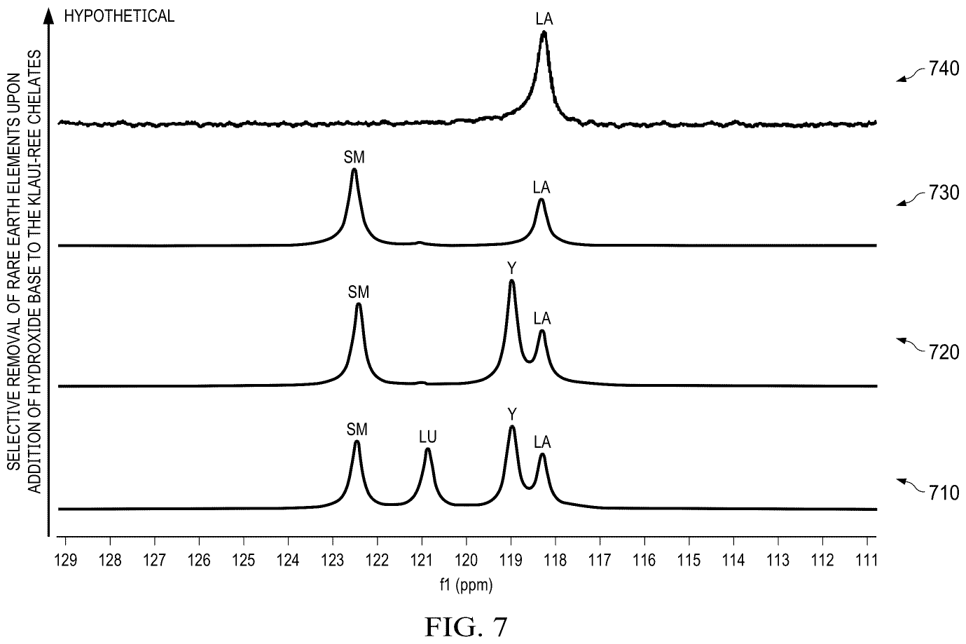

FIG. 7 presents simulated data based on preliminary evidence suggesting that the addition of sodium hydroxide, in conjunction with Kläui chelation, may be applicable for the selective separation of rare earth elements. FIG. 7 illustrates a series of traces starting with a mixture of Kläui-rare earth chelates 710 containing samarium (Sm), lutetium (Lu), yttrium (Y), and lanthanum (La).

The traces show the sequential removal of the elements as sodium hydroxide is progressively added to the solution. Initially, lutetium is removed from the mixture, followed by yttrium and samarium, ultimately leaving lanthanum as the last element in the solution. Trace 720 shows an absence of lutetium. Trace 730 shows an absence of Yttrium. Trace 740 shows only lanthanum remaining. This simulation demonstrates the potential of embodiments of this disclosure for the selective separation of rare earth elements, with lanthanum being the last element to be removed.

FIG. 7 is hypothetical but is grounded in preliminary experimental data, and it serves to highlight the promising application of Kläui chelation for rare earth element separations, facilitated by the addition of sodium hydroxide. This capability could significantly enhance the utility of embodiments of this disclosure in various industrial and research settings where specific rare earth element separation is required.

### Definitions

The term uniformly is intended to mean unvarying or deviating very little from a given and/or expected value (e.g, within 10% of). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub) method, (sub) process and/or (sub) routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations. Homologous replacements may be substituted for the substances described herein. Agents which are chemically related may be substituted for the agents described herein where the same or similar results would be achieved.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. A method, comprising:
bonding chemically a set of rare earth elements to a set of metallophosphonic acid chelates to form a set of chelation complexes; and
detecting at least one of the set of rare earth elements in the set of chelation complexes using nuclear magnetic resonance.

2. The method of claim 1, wherein the set of metallophosphonic acid chelates comprise a set of Kläui ligands, wherein detecting includes detecting specific individual elements from among the set of rare earth elements.

3. The method of claim 2, further comprising dissolving at least a fraction of the set of chelation complexes in water.

4. The method of claim 2, further comprising dissolving at least a fraction of the set of chelation complexes in an organic solvent.

5. The method of claim 4, further comprising dissolving at least another fraction of the set of chelation complexes in water.

6. The method of claim 1, further comprising dissolving at least a fraction of the set of chelation complexes in water.

7. The method of claim 1, further comprising dissolving at least a fraction of the set of chelation complexes in ethyl acetate organic solvent.

8. A method, comprising:
bonding chemically a set of rare earth elements to a set of metallophosphonic acid chelates to form a set of chelation complexes; and
separating at least one of the set of rare earth elements in the set of chelation complexes using at least one solvent.

9. The method of claim 8, wherein the set of metallophosphonic acid chelates comprise a set of Kläui ligands, wherein detecting includes detecting specific individual elements from among the set of rare earth elements.

10. The method of claim 9, further comprising dissolving at least a fraction of the set of chelation complexes in water.

11. The method of claim 9, further comprising dissolving at least a fraction of the set of chelation complexes in an organic solvent.

12. The method of claim 11, further comprising dissolving at least another fraction of the set of chelation complexes in water.

13. The method of claim 8, further comprising dissolving at least a fraction of the set of chelation complexes in water.

14. The method of claim 8, further comprising dissolving at least a fraction of the set of chelation complexes in ethyl acetate organic solvent.

15. A method, comprising:
bonding chemically a set of rare earth elements to a set of metallophosphonic acid chelates to form a set of chelation complexes;
detecting at least one of the set of rare earth elements in the set of chelation complexes using nuclear magnetic resonance; and
separating at least one of the set of rare earth elements in the set of chelation complexes using at least one solvent.

16. The method of claim 15, wherein the set of metallophosphonic acid chelates comprise a set of Kläui ligands, wherein detecting includes detecting specific individual elements from among the set of rare earth elements.

17. The method of claim 16, further comprising dissolving at least a fraction of the set of chelation complexes in water.

18. The method of claim 16, further comprising dissolving at least a fraction of the set of chelation complexes in an organic solvent.

19. The method of claim 18, further comprising dissolving at least another fraction of the set of chelation complexes in water.

20. The method of claim 15, further comprising dissolving at least a fraction of the set of chelation complexes in water.

21. The method of claim 15, further comprising dissolving at least a fraction of the set of chelation complexes in ethyl acetate organic solvent.

22. A method, comprising:
providing a set of chelation complexes comprising a set of Kläui ligands;
reacting the set of Kläui ligands with at least one hydroxide base; and
producing a free Kläui chelate as a sodium salt.

23. The method of claim 22, wherein the at least one hydroxide base comprises at least one of sodium hydroxide, potassium hydroxide, lithium hydroxide, rubidium hydroxide, cesium hydroxide, ammonium hydroxide, and combinations thereof.
